(19) United States
(12) Patent Application Publication
(10) Pub. No.: US 2008/0218539 A1
(43) Pub. Date: Sep. 11, 2008

(54) INKJET PRINTING PARTIALLY IMAGED PANELS WITH SUPERIMPOSED LAYERS

(75) Inventors: G. Roland HILL, Stockport (GB); Phillip John Reynolds, Stockport (GB)

Correspondence Address: PILLSBURY WINTHROP SHAW PITTMAN, LLP, P.O. BOX 10500, MCLEAN, VA, 22102, US

(73) Assignee: Contra Vision Limited, Cheshire (GB)

(21) Appl. No.: 12/045,164

(22) Filed: Mar. 10, 2008

Related U.S. Application Data
(60) Provisional application No. 60/893,768, filed on Mar. 8, 2007.

(51) Int. Cl. B41J 2/195

(52) U.S. Cl. 347/7

(57) ABSTRACT

A panel and method for making the panel are disclosed. The panel includes a substrate sheet partially imaged with a print pattern. The print pattern subdivides the panel into a plurality of discrete printed areas and/or a plurality of discrete unprinted areas. The design is superimposed on or forms a part of said print pattern. The design comprises a design layer. The print pattern includes a base layer. The print pattern includes elongate printed areas orientated lengthways in one direction. The design layer and base layer include inkjet printable ink in elongate ink deposits orientated lengthways in the one direction. The elongate ink deposits may have an aspect ratio of length:width greater than 1.5:1. The base layer may include white ink. The panel may be made using a digital inkjet cylindrical printer that prints the base layer during at least 10 revolutions of the cylinder.

### CROSS-REFERENCE

This application claims the benefit of priority to U.S. Provisional Patent Application No. 60/893,768, titled “Inkjet Printing Partially Imaged Panels with Superimposed Layers,” filed on Mar. 8, 2007, the entire contents of which are incorporated herein by reference.

### BACKGROUND OF THE INVENTION

1. Field of the Invention

The present invention relates generally to the field of inkjet printing partially printed panels with superimposed layers, for example see-through graphic panels comprising a design superimposed on a print pattern selectively applied to a substrate.

2. Description of Related Art

Inkjet printing partially imaged panels in the form of see-through graphics panels, for example according to U.S. RE37,186 and U.S. Pat. No. 6,212,805, is disclosed in U.S. Pat. No. 6,507,413, U.S. Pat. No. 6,899,775, PCT/GB2006/000601 and U.S. Patent Application No. 2006/0260489. PCT/GB2006/000601 and U.S. Patent Application No. 2006/260489 also disclose the difficulties of inkjet printing white ink and superimposed layers of ink. Such partially imaged panels typically comprise a base layer of white ink, typically to act as a background to design layer inks, for example four color process inks of cyan, magenta, yellow and black. None of the above references disclose the use of an inkjet printer comprising a rotating cylinder or drum on which a substrate is positioned and inkjet printed. PCT/GB2006/000601 discloses six printing sequences of printing a panel, including printing sequence 1 in which a substrate sheet is first printed with a base layer within a print pattern, followed by a second stage of printing a design superimposed on the base layer within the print pattern. It also describes four inkjet printer movement mechanisms 1-4 and, for each, the relative movement of a printhead array in relation to a substrate sheet but does not disclose the movement mechanism of inkjet cylindrical printers with hardly discernible movement of a printhead array and does not disclose the use of white ink with inkjet cylindrical printers.

Inkjet cylindrical printers are known, for example a range of printers known as the Idanit, the PressJet and the TurboJet manufactured by Scitex or HP Scitex, a division/subsidiary of Hewlett-Packard Inc., USA. All three machines have been supplied to print with solvent inks. These machines are configured such that one or more substrate sheets are placed on the cylinder or drum which is perforated and acts as a cylindrical vacuum suction “bed” to hold the substrate sheets firmly in place while the cylinder or drum is being rotated to print a design by means of printheads supplying cyan, magenta, yellow and process black solvent ink with an option of two additional colors, typically light cyan and light magenta. The cylinder axis is orientated horizontally and individual printheads are orientated horizontally, offset horizontally and disposed along the length of the cylinder end-to-end, and stacked in the desired order of colors, for example in the order CMYK, on a single “bridge” support. There are many more printheads than in other inkjet machines, for example 150 printheads in an HP Scitex TurboJet, compared to typically between 4 and 21 printheads for other commercially available inkjet printing machines. However, in order to provide the desired ink coverage and to overcome “banding” which would otherwise be caused by this arrangement, the bridge and therefore the printhead array is moved a very short distance sideways, of the order of seven centimetres over the time period of completing a printing process, moving relatively very slowly compared to the speed of movement of printheads in other inkjet machines, for example with any one of the movement mechanisms disclosed in PCT/GB2006/000601. These inkjet cylindrical printers have been configured to apply the desired amount of ink on the substrate sheet in a relatively short timescale owing to the large number of printheads disposed along the length of the drum and the speed of rotation, whereupon the substrate sheet is discharged onto a conveyor belt and through a conventional solvent ink drying tunnel, for example a hot air drying tunnel. While the one or more substrate sheets that have just been printed are being cured or dried, the printing drum can be loaded with the next substrate sheet or sheets and printing can recommence.

It is impossible with such machines to accurately register one layer of ink to another layer previously applied and cured in a separate curing process remote from the cylinder. In 2006, a version of the HP Scitex TurboJet, the HP Scitex TJ8500, was introduced, capable of printing UV ink with six ink channels or ink stations, typically cyan, magenta, yellow, process black, light cyan and light magenta, cured by a UV lamp assembly disposed along the cylinder length. White ink is not supplied or cited as an option with this or any other inkjet cylinder machine.

There are known problems with inkjet printing white ink, and the more “opaque” it is desired to make the printed white ink (having a relatively high Transmission Optical Density or TOD), the more these difficulties are exacerbated. In prior art methods of UV digital inkjet printing such panels, it is required to have a higher proportion of white pigment in an ink than typically is required of other inks. Also, it is known that white inkjet inks need to be agitated in the ink reservoir to avoid or reduce pigment settlement and/or flocculation. There is no prior art of an inkjet cylindrical printer being used to print separate, superimposed layers, for example in the manner of a design superimposed on a base layer or vice versa.

While a range of other types of digital UV inkjet printing machines have been introduced onto the market with a white ink option, none have white ink delivered to printheads which move relatively slowly compared to the speed of movement of the substrate, that is in the secondary direction of relative movement of the printheads to the substrate. White ink has only been introduced into machines which have relatively fast movement of the printheads, maintaining the ink in a relatively consistent, agitated state from an agitated ink reservoir through the supply lines to delivery of the ink onto the substrate. For example white ink has been introduced as an option for the Inca Spyder machine, which has a relatively fast moving printhead array moving across a bridge which moves slowly down the length of a fixed vacuum suction bed on which the substrate is held, whereas the Inca Columbia machine, which has a relatively slow moving printhead moving across a bridge while the vacuum suction bed holding the substrate moves rapidly backwards and forwards, does not have a white ink option. Inca Spyder and Inca Columbia are trademarks of Inca Digital Printers, UK, a division of Dai Nippon Screen Company, Japan.

### SUMMARY OF EMBODIMENTS OF THE INVENTION

According to one aspect of one or more embodiments of the invention, a panel comprises a substrate sheet partially imaged with a print pattern, said print pattern subdividing the panel into a plurality of discrete printed areas and/or a plurality of discrete unprinted areas, said design being superimposed on or forming a part of said print pattern, said design comprising a design layer, said print pattern comprising a base layer, said print pattern comprising elongate printed areas orientated lengthways in one direction, said design layer and said base layer comprising inkjet printable ink in elongate ink deposits orientated lengthways in said one direction, said elongate ink deposits having an aspect ratio of length:width greater than 1.5:1.

According to another aspect of one or more embodiments of the invention, a panel comprises a substrate sheet partially imaged with a print pattern, said print pattern subdividing the panel into a plurality of discrete printed areas and/or a plurality of discrete unprinted areas, said design being superimposed on or forming a part of said print pattern, said design comprising a design layer, said print pattern comprising a base layer and another base layer, said print pattern comprising a primary print pattern and a secondary print pattern, wherein a cross-section can be taken through said panel comprising said sheet and alternate printed portions and unprinted portions, said printed portions comprising a plurality of primary print pattern portions and a plurality of secondary print pattern portions, and wherein each of said plurality of primary print pattern portions comprises a part of said base layer having two outer edges and a part of said another base layer having two outer edges, wherein said two outer edges of said part of said base layer are located within said two outer edges of said part of said another base layer, wherein in one of said primary print pattern portions said part of said design layer extends over only part of said width between said two outer edges of said part of said another base layer, and wherein a plurality of said plurality of secondary print pattern portions comprise other parts of said base layer having two outer edges and are devoid of said another base layer.

Another aspect of one or more embodiments of the invention provides a method of making a panel, said panel comprising a substrate sheet partially imaged with a print pattern, said print pattern subdividing the panel into a plurality of discrete printed areas and/or a plurality of discrete unprinted areas, said design being superimposed on or forming a part of said print pattern, said design comprising a design layer, said print pattern comprising a base layer, said method comprising the steps of:
(i) providing a digital inkjet cylindrical printer comprising a cylindrical drum to support said substrate sheet and an array of inkjet printheads,
(ii) locating said substrate sheet onto said cylinder,
(iii) rotating said cylindrical drum,
(iv) inkjet printing said substrate sheet while said cylinder is rotating with a first layer, said first layer comprising one of said design layer and said base layer,
(v) then printing a second layer, said second layer comprising the other of said design color and base layer, both said design layer and said base layer being located within said print pattern.

Typically, the base layer comprises a light-reflective layer, typically a white ink layer, typically as a background to design layer inks, optionally applied to a “light permeable material”, for example a water clear, transparent polyester film, or a colored substrate, for example colored pvc sheet material.

The term “light permeable material” as used herein is intended to mean a material that allows light to pass through it and includes both “transparent material” and “translucent material”. The light permeable material is typically imperforate, although it should be understood that this does not preclude the incorporation of holes, for example for fixing the panel, the light permeable material remaining substantially imperforate. Accordingly, light permeable materials may be perforated without deviating from the scope of the present invention.

The term “transparent material” as used herein is intended to mean a light permeable material that has two substantially parallel and plane surfaces or otherwise allows clarity of vision from one side of the material through the material, enabling the eye to focus on an object spaced from the other side of the material and thus providing a substantially undistorted image of the object. The transparent material is optionally colorless or “water clear” or tinted to any required color.

The term “translucent material” as used herein is intended to mean a material which will allow light transmission but is not a transparent material (as defined herein).

Examples of light permeable materials include: rigid or semi-rigid sheet material, for example of glass, acrylic, polycarbonate, polyvinyl chloride, crystal polystyrene, polypropylene or polyester, or filmic material, for example of polycarbonate, polyvinyl chloride, polypropylene or polyester. Clear, self-adhesive film assemblies with an opaque liner to be removed before application to a window are included within the term light permeable material, the resultant panel comprising a window, adhesive layer and printed film layer being light permeable.

The term “design” as used herein is intended to mean any graphic image such as indicia, a photographic image or a colored image of any type. Optionally, the design is perceived to be visually independent of the print pattern elements, for example in vision control panels according to U.S. RE37,186 or U.S. Pat. No. 6,212,805. This feature can be tested by an observer. If the observer adjacent to one side of the panel from which the design is normally visible moves away from the one side of the panel in a perpendicular direction from the panel until individual print pattern elements can no longer be resolved by the eye of the observer, the design remains clearly perceptible to the observer. The design comprises at least one “design layer” and, optionally, the design also comprises part of a base layer, typically seen by an observer as a background to a design layer.

A “design layer” comprises a single or “spot” design color layer and/or a multi-color process layer, for example a four color process of cyan, magenta, yellow, black (CMYK). The design layer may also include additional colors to improve apparent gradation within the image, typically cyan and magenta of reduced density commonly known as light or dilute cyan and magenta in a six color process (CMYKC_{L}M_{L}). The design layer may also include additional colors designed to extend the number or gamut of accurately rendered colors available from a four color ink set. Blue, red, orange, green and violet are well known though practically any known colour can be formulated by practitioners of the art and serve either as an additional or substitute colour. The design layer comprises an agglomeration of overlapping and/or contiguous and/or spaced deposits of ink, the individual deposits typically being of maximum width less than 3 mm and typically less than 1 mm.

A “design color layer” is a single color layer within a design layer, for example of cyan or magenta or yellow or black in a four color process design layer.

The term “translucent design layer” as used herein is intended to mean a design comprising translucent material (as defined herein). A translucent design layer typically comprises translucent inks, toners or other marking materials. Another part of a translucent design may be opaque. Another part of a translucent design may comprise transparent material. A design color layer comprises an agglomeration of overlapping and/or contiguous and/or spaced deposits of ink, the individual deposits typically being of maximum width less than 3 mm and typically less than 1 mm.

The term “print pattern” as used herein is intended to mean the geometric pattern within which the plurality of ink layers are located and all the edges of the print pattern are coincident with an edge of at least one of the plurality of ink layers. The print pattern comprises a plurality of connected and/or unconnected print pattern elements. The print pattern subdivides the panel into a plurality of discrete printed areas and/or a plurality of discrete unprinted areas. The print pattern may be in many forms, for example it may be a regular geometric element in a regular layout, such as a uniform pattern of hexagons or circular dots, a regular geometric element in an irregular layout, a free form element in a regular layout, a free form element in an irregular layout or a combination of regular and free-form elements in regular and/or irregular layouts. Instead of a number of discrete (separate) elements with an interconnected unprinted zone, the print pattern can be a pattern of discrete print pattern elements and discrete unprinted areas, such as a pattern of lines. Alternatively, the print pattern may be formed by interconnected print pattern elements with discrete unprinted areas, such as net, grid or mesh pattern. The print pattern can, if desired, be a combination of interconnected print pattern elements and discrete print pattern elements. The print pattern advantageously comprises connected or unconnected stochastic elements in a random or pseudo-random distribution of print pattern elements, to mitigate known problematic effects such as Moiré patterns arising from the relative position of design layer elements and print pattern elements or design elements such as indicia being partly eliminated by unprinted portions between portions of the print pattern. The elements forming the print pattern are normally small, such as dots, preferably of equal size on a regular grid, sometimes referred to in the printing industry as a “half tone”, or a fine pattern of lines, or a grid pattern. The print pattern for vision control panels according to U.S. RE37,186 or U.S. Pat. No. 6,212,805 is typically a continuum and provides an even shading or tinting effect in the absence of a design. The print pattern optionally comprises a primary print pattern, for example of regular geometric elements in a regular layout and a secondary print pattern of ink deposits, typically in a random layout, for example caused by “spatter” in inkjet printing. Optionally, the print pattern is uneven, for example comprising the indicia of a sign.

The term “base layer” as used herein is intended to mean a single layer of a single color of digitally printed ink within the print pattern. The base layer comprises an agglomeration of overlapping and/or contiguous and/or spaced deposits of ink, the individual deposits typically being of maximum width less than 3 mm and typically less than 1 mm. A base layer typically is of the same geometric pattern as the print pattern but can be a different pattern beyond which other base layers and/or the design layer may extend, all within the print pattern. Base layers are optionally light-reflective, preferably white, for example acting as a background to a design layer, or are light-absorbing, typically black, for example visible from a side of a transparent panel from which it is desired to provide good through vision. Optionally, a base layer extends beyond a primary print pattern to define or form part of a secondary print pattern, for example as spattered ink outside a computer-defined primary print pattern.

A cross-section can be taken through a panel printed by methods according to one or more embodiments of the invention which comprises two outer edges of the substrate sheet and alternate printed portions and unprinted portions, said printed portions comprising a base layer and a design color layer, and a plurality of said printed portions comprising a part of said base layer and at least one of said plurality of printed portions comprising a part of said design color layer. The widths of the printed portions are typically less than 5 mm, preferably less than 3 mm, and optionally less than 1 mm. The widths of the unprinted portions are typically less than 3 mm, preferably less than 1 mm, and optionally less than 0.5 mm.

Methods according to one or more embodiments of the invention can be used, for example, to make many different types of vision control panels printed on light permeable materials, for example so-called one-way vision panels according to U.S. RE37,186 with a design visible from one side of the panel but not visible from the other side, or see-through graphics panels according to U.S. Pat. No. 6,212,805, the latter having a translucent base layer and a translucent design layer which can be seen from one side and can be illuminated from the other side. If the base layer or base layers are opaque and the design layer is superimposed onto the base layer or base layers with substantially exact registration or within the base layer or base layers then the design is visible from one side of the panel and is not visible from the other side of the panel. Optionally, a first design is visible from a first side of the panel and is not visible from the other side of the panel and a second design is visible from the other side of the panel but not visible from the first side of the panel. Alternatively, the design can extend beyond the edges of the base layer(s), providing the light permeability characteristics of the panel are maintained, for example providing a light transmissivity of at least 10%, in this context light transmissivity meaning the percentage of radiation within the visible spectrum which is incident on one side of the panel which is transmitted to the other side of the panel. Typically, the light permeable material is a transparent material, to allow a degree of through vision.

The print pattern optionally comprises translucent layers as disclosed in U.S. Pat. No. 6,212,805, typically a white translucent base layer and a translucent design layer which is visible from one side of the panel and a mirror image of the design layer is visible from the other side of the panel when a sufficiently high level of illumination is provided on either or both sides of the panel.

Additional and/or alternative objects, features, aspects, and advantages of the present invention will become apparent from the following description, the accompanying drawings, and the appended claims.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIG. 1 is a diagrammatic cross-section through a UV inkjet cylinder printing machine;

FIGS. 2 and 3 are diagrammatic elevations of printhead arrays;

FIG. 4A-C are diagrammatic plans of panels;

FIG. 4D is a diagrammatic cross-section through part of a panel;

FIGS. 5A-C are diagrammatic plans of panels;

FIGS. 5D and E are diagrammatic cross-sections through panels;

FIGS. 6A-G are diagrammatic cross-sections through printed portions on a panel; and

FIGS. 7A and B are diagrammatic cross-sections through part of a panel.

### DETAILED DESCRIPTION OF EXEMPLARY EMBODIMENTS OF THE INVENTION

In a first embodiment of the invention, an inkjet cylindrical printer comprises a cylindrical drum and means of firmly locating a substrate sheet on the drum, for example an aluminum or carbon composite drum being perforated and having a vacuum suction system. A first type of inkjet cylindrical printer comprises a plurality of printheads supplying CMYK and white (W) solvent inkjet ink. Optionally, the inkjet cylindrical printer has a solvent ink curing arrangement enabling the first layer of ink to be cured or partially cured while the substrate sheet is still located on the cylinder, for example by hot air blowers disposed along the length of the cylinder, typically remote from the printheads to avoid drying up the inkjet nozzles. A base layer of white ink is first printed in a first layer within a print pattern during a plurality of rotations of the cylinder, during which only white ink is printed onto the substrate sheet. A manual, software or firmware instruction is provided to the machine to prevent the normal process of substrate sheet ejection after this first layer printing operation. There is then provided a manual, software or firmware instruction to commence a second layer of printing comprising the design layer. Optionally, curing comprising cold or hot air blowing is provided during and/or after the printing of the first layer and optionally the second layer while the substrate sheet is on the drum. For example, along the opposite side of the drum to the line of inkjet printhead arrays, there is provided hot air blown through a series of electrical heating elements during printing the first layer and optionally after completing the printing of the first layer during continued rotation of the drum, and optionally during printing the second layer and optionally after printing the second layer, before ejection of the printed substrate after printing the final required layer. This method of curing solvent inks may be relatively efficient because the rotation of the cylinder increases the air velocity relative to the substrate compared to the blown air speed in a conventional solvent ink drying tunnel. Optionally, both layers are cured or further cured after printing in a conventional drying tunnel remote from the drum.

For products printed on a transparent substrate in which it is desired to see the printed design through the substrate, for example for internal application window graphics, the order of printing may be changed, for example via a reverse-printed design being followed by a white base layer.

In prior art inkjet cylinder printers the software automatically loads, prints and ejects the printed substrate sheet once the operator has pressed a “print” instruction button.

According to one aspect of one or more embodiments of the present invention, it is required to provide disruptive and manual, software or firmware (software in the printer) instructions to the inkjet cylinder printer to suspend ejection of the substrate sheet after printing the first layer and to commence printing the second layer, as inkjet cylindrical printers are typically designed and programmed to print one layer, typically comprising multiple deposits of cyan (C), magenta (M), yellow (Y) and process black (K) ink.

A dislocating routine to allow a prior art inkjet cylinder machine to print a plurality of layers in separate steps may be required, for example:
(i) create the computer artwork files for each layer separately, for example for a four color process design layer and a white base layer,
(ii) transfer the files to an artwork “queue” in the printer,
(iii) retrieve the white base layer file from the queue,
(iv) instruct the printer to load the substrate,
(v) press the “print” instruction button as normal, resulting in printing the first layer,
(vi) when the indicator light comes on to notify the operator that the printing process has been completed, press the “stop” instruction button and then the “jog drum” instruction button,
(vii) retrieve the four color process files from the queue, and
(viii) press the “print” instruction button. The substrate sheet printed with both layers automatically ejects when the printing of the second layer is completed.

A second embodiment of the invention is similar but comprises a second type of inkjet cylindrical printer printing UV-curable ink. UV curing lamps are typically located in a UV lamp head remote from the printhead array such that the UV ink applied in a single rotation of the drum is cured after being deposited onto the substrate sheet before the next application of ink in the next single rotation of the drum.

Whether the ink is solvent ink or UV ink, drum rotation can cease or be continued between printing the two layers.

Such inkjet cylinder printing machines typically have many more printhead arrays than other types of inkjet machines. For example, the HP Scitex TJ8500 comprises 150 inkjet printheads with 98 nozzles per printhead distributed along the length of the cylinder, whereas other inkjet machines have as few as four and typically not more than twenty-one inkjet printheads. The printheads are optionally heated for optimum rheology of the inkjet ink for printing purposes. Because the drum can be rotated extremely fast, for example more than 20 and optionally more than 30 revolutions per minute, providing a typical relative speed of substrate sheet to printheads of more than 1 metre per second at the surface of the drum, in conjunction with the large number of printheads, the printing output, for example in terms of square metres per hour, is typically far higher than other types of inkjet printing machines, for example up to 400 m²/hr being claimed for normal CMYK printing in a single layer on the HP Scitex TJ8500. The printheads are optionally stationary. Typically, the printheads move extremely slowly, for example at less than 2 mm per second and optionally less than 1 mm per second, much slower than other inkjet printers and of the order of one thousandth of the speed of the substrate. However, the present method also applies to an inkjet cylindrical printer with as few as five printheads comprising CMYK+White moving along the length of the cylinder at a speed which is still relatively slow compared to the relative speed of the substrate sheet to the printhead array.

One or more embodiments of the invention include the use of an inkjet cylindrical printer, and the optional use of a white ink in conjunction with the stationary or relatively very slowly moving printheads of an inkjet cylinder printing machine.

One or more embodiments of the invention use a white ink of relatively low opacity or Transmission Optical Density (TOD) that can be adopted with an inkjet cylindrical printer because of the number of revolutions and speed of application of multiple layers of ink to build up the required translucency or opacity (TOD) in a white base layer in, for example, over 10, or over 20, or over 30, or over 40 rotations of the cylinder drum in a relatively fast time compared to various prior art digital printing methods. According to various embodiments of the present invention, any required degree of translucency or opacity (TOD) can be achieved in a white base layer, to suit the product being printed, by selecting the appropriate number of revolutions by experience or prior testing of an ink with a relatively low proportion of white pigment. Thus the prior art problems of white ink management are overcome according to one or more embodiments of the invention, especially in the use of stationary or relatively slow moving printheads and supply tubes to those printheads, because a white ink of relative low proportion of white pigment, for example of titanium dioxide, of less than 15%, preferably less than 12.5%, and more preferably less than 10% by weight can be used.

One or more embodiments of the invention also provide the disruptive mechanical, software or firmware instructions to an inkjet cylinder printer, to suspend the substrate sheet ejection until after the printing of the second layer, and optionally after farther layers are printed, for example an optional black layer and/or an optional “silver” or gray layer. A “silver” or gray ink layer intermediate black and white ink layers is a known method of increasing the perceived whiteness of the white ink layer. “Silver” or gray inks typically utilise an aluminium pigment. A white base layer is typically required as background to a design layer, for example comprising a four color process, CMYK design layer, or six color process CMYK, light cyan (C_{L}) and light magenta (M_{L}) design layer. One or more embodiments of the invention also provide a manual, software or firmware instruction to commence printing a second layer before ejection of the substrate sheet from an inkjet cylindrical printer. Furthermore, in the case of solvent ink, one or more embodiments of the invention utilize curing on the cylindrical drum.

Because of the typically extremely fast primary direction of movement of the substrate sheet relative to the printheads in such inkjet cylinder machines, ink deposits tend to be elongated in the direction of movement of the surface of the cylinder, termed “elongate ink deposits” herein. More ink “spatter” and projection of elongate ink deposits is typically visible from the desired edges of printed ink which are parallel to the axis of the cylinder than perpendicular to the axis of the cylinder. It is therefore typically advantageous, for example in the manufacture of see-through graphics panels, to arrange a print pattern of elongate areas, for example a pattern of lines, to be orientated lengthways circumferential to the cylinder (perpendicular to the axis of the cylinder rather than parallel to the axis of the cylinder) or, for example, a pattern of hexagons to be orientated lengthways so that two parallel sides of the hexagons are perpendicular to the axis of the cylinder, to minimise the amount of spatter and elongate ink deposit projection from the desired print pattern. It should be understood that the actual print pattern encompasses the imaged area, including such spatter and projection outside a theoretical geometric definition of the print pattern, for example a pattern of lines or hexagons. Such an arrangement of elongate print pattern elements and parallel elongate ink deposits may provide better edge registration of ink deposits within a theoretical print pattern geometry than prior art methods, for example if the aspect ratio (ratio of length:width of elongate ink deposit) is greater than 1.5:1, more preferably greater than 2:1 and even more preferably greater than 2.5:1.

It has been found typically preferable for a panel comprising a single base layer of white ink, for example according to U.S. Pat. No. 6,212,805, to have white base layer portions of slightly smaller cross-sectional width than the design layer, as white ink spatter is particularly noticeable and is often perceived as being undesirable for such products. Some standard suites of software or firmware for inkjet printing machines include the option of “choking” (insetting) the perimeter of a particular element to be printed. Alternatively, suitable artwork can be provided for the printing of layers of slightly different cross-sectional widths, for example according to the disciplines of U.S. Pat. No. 6,210,776 or U.S. Pat. No. 7,087,291, for example in order to achieve desired color rendering or perceived color in panels printed according to U.S. RE37,186 with both a black base layer and a white base layer.

Whereas it is typically desired to minimize ink spatter, surprisingly, it has been found that panels having substantial inkjet spatter can provide advantageous visual effects. For example, such panels provide a greater degree of privacy combined with a relatively high level of light transmission than provided by prior art perforated vinyl window graphic materials, for example according to U.S. Pat. No. 5,858,155, or exact registration printing on transparent imperforate substrates according to U.S. RE37,186 or overlap registration printing according to U.S. Pat. No. 6,210,776 or U.S. Pat. No. 7,087,291. These prior art methods can be used to create one-way vision panels with a design visible from one side and a black or other dark pattern visible from the other side enabling good through vision. With these prior art panels, through vision is still possible through the design from the design-facing side, if there is sufficient illumination on the other side. However, panels according to the second aspect of the present invention having a secondary print pattern comprising substantial white ink spatter outside the geometrically defined primary print pattern have been found to provide a more effective privacy effect from the design side by virtue of illumination from either side of the spattered white ink. While some through vision from a relatively dark other side to a relatively well illuminated design-facing side is still possible, vision from the design side is typically totally obscured, as the very small illuminated white ink deposits prevent vision through the transparent sheet material surrounding them. Colored inks, for example spattered CMYK inks, also tend to obscure through vision but not as effectively as spattered white ink or other highly reflective inks. Furthermore, novel and interesting visual effects are possible, especially when backlit from the other side according to U.S. Pat. No. 6,212,805, the white ink deposits providing tiny highlights in the manner of stars in the sky or spectral reflections of incident light on textured reflective surfaces. The individual ink deposits of the random secondary print pattern are typically of much smaller area and width than the geometrically defined elements of the primary print pattern, typically less than 0.2 mm² area and less than 0.5 mm width, providing a finely speckled appearance. Whereas, as previously explained, a primary print pattern of elongate areas circumferential to the drum minimizes inkjet spatter, elongate areas parallel to the axis of the drum can be adopted to increase spatter for such special effects. Alternatively, a secondary print pattern can be achieved, for example of a very fine consistent density over the otherwise transparent area or areas outside the primary print pattern, by providing suitable computer-defined artwork, for example in discrete areas too small to be able to accurately superimpose layers as required by the primary print pattern, for example by inkjet cylindrical printing, typically less than 0.2 mm² area and less than 0.5 mm width, whereas the width of portions of the primary print pattern is typically greater than 0.5 mm. Such techniques for providing a fine secondary print pattern are particularly useful for geometric abstract designs, for example for partition panels in buildings. A very fine pattern of light-reflective inks, for example caused by white ink spatter, on an illuminated transparent material, has a visual effect similar to translucency, light can pass but through vision is obscured. To achieve notable obscuration or translucency or illuminated highlights in the otherwise transparent areas, the secondary print pattern or spatter preferably covers at least 5% and preferably greater than the 10% and more preferably greater than 20% of the otherwise transparent area or areas outside the primary print pattern.

According to various embodiments, a particular cross-section through a panel comprising a primary print pattern of lines, the aggregate width of the secondary print pattern portions, typically comprising discrete areas of ink on plan, is at least 10% and preferably more than 20% and even more preferably more than 30% of the aggregate width of the primary print pattern portions.

Special, high opacity (TOD) white ink with a high percentage of titanium dioxide is offered by manufacturers for the prior art printing of such vision control (see-through graphic) panels, for example special UV inkjet white ink supplied by EFI VUTEk, USA, whereas methods according to one or more embodiments of the invention allow the use of white ink of relatively low percentage of white pigment and consequently relatively low opacity (TOD), for example having a proportion of titanium dioxide white pigment less than 15%, preferably less than 12.5 and more preferably less than 10% by weight.

Even with the advantages of one or more embodiments of the present invention, which allow a less opaque white ink to be used than prior art inkjet printing of a white ink base layer, it is preferable to agitate the white ink reservoir, for example with one or more ferrous paddles rotated by a magnetic field produced by an external motor. It is advisable to flush or purge white ink supply lines with as much frequency and preferably more frequently than other inks, for example CMYK inks. Optionally, vibration devices, for example having an eccentric rotating element, are attached to, for example clipped to, white ink supply lines. The ink channels typically comprise a filter and the white ink filter should be replaced regularly, for example before each day of use of the machine with a white ink.

The single direction of rotation of the drum provides a unidirectional application of ink. This unidirectional application of design layer inks allows the optimum sequential order of printing a four color process design layer, in the order of CMYK inks, so that high quality of print is possible with the high productivity of the method, resulting from there being no reverse movements of the printheads or substrate, as well as because of the number of printheads and possible speed of rotation of the drum.

Prior art inkjet printers with frictional feed of the substrate are not accurate enough in registration to reverse feed the substrate to provide superimposed layers. Some prior art inkjet printers do not even have a reverse substrate option. To overcome these problems, PCT/GB2006/000601 discloses methods of offsetting printheads or only using part of the length of each printhead to enable a single pass of a substrate through such machines, which is less efficient in printhead deployment than one or more embodiments of the present invention.

It has been found according to one or more embodiments that see-through graphics panels according to U.S. RE37,186 with an opaque silhouette pattern can be made to a satisfactory commercial standing by printing a transparent self-adhesive polyester film substrate with a CMYK (combined) black layer in 27 rotations, a white base layer in 27 rotations and a design layer in 27 rotations of an HP Scitex TJ8500 UV inkjet cylinder printing machine with 150 Hitachi-Koki E1 printheads, each with 96 nozzles, at typical machine settings, using NAZDAR Special Lyson 694656UO White UV Piezo Inkjet Ink with a titanium dioxide white pigment of less than 12.5% by weight, which was specially sought and developed for this purpose, other inks being standard HP Scitex UV inkjet inks, which do not include a white option. The special white ink formulated for this embodiment of the invention also includes an anti-agglomeration (anti-flocculant) additive and is a relatively flexible UV ink suited to application to and use with flexible films.

An embodiment of the invention was also reduced to practice to make see-through graphics panels according to U.S. Pat. No. 6,212,805 with a translucent base layer by printing a white base layer in 27 rotations, a design layer in 27 rotations of the same UV inkjet cylinder printing machine, using the same inks, also on a self-adhesive polyester film substrate.

The embodiments of the invention are not limited to making see-through graphics panels but include any partially imaged panel with superimposed layers, for example discrete indicia with an underlying white base layer on an otherwise unprinted and exposed transparent, translucent or opaque substrate sheet.

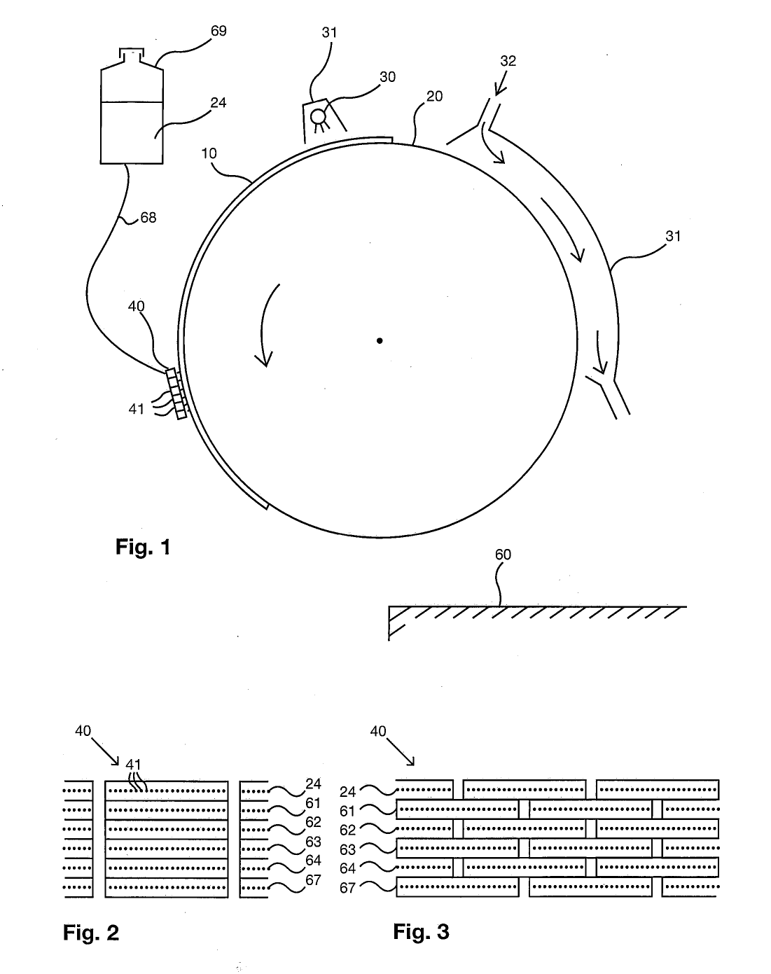

FIG. 1 is a diagrammatic cross-section through an inkjet cylinder printing machine comprising rotating drum 20, for example having a perforated carbon fiber composite outer shell and an internal vacuum suction system capable of being selectively applied to hold down substrate 10, in order that it can be printed by a printhead array 40 comprising individual inkjet printheads 41. One of the printheads 41 is supplied with white ink 24 from ink reservoir 69 by supply tube 68 which is diverted by a manifold (not shown) to supply the individual inkjet printhead 41 with the white ink “channel”. The white ink 24 is agitated, for example by magnetically-driven ferrous paddles, and the ink supply tube 68 is optionally agitated, for example by a vibration device, for example comprising an electrically rotated eccentric mass, clamped to one or more parts of the ink supply channel. An optional curing device comprises a UV curing lamp 30 in cowling 31 for curing UV ink. An optional or additional curing device comprises a hot air supply system 32 for curing solvent ink, under another cowling 31. In either case, the ink is typically cured during the printing process comprising a number of revolutions of the drum 20 and optional longitudinal or sideways movement of the printhead array 40, sufficient to provide the required degree of ink cover and to prevent or limit “banding” caused by the separation of individual printheads, for example as illustrated in FIGS. 2 and 3. FIG. 2 illustrates a printhead array 40 comprising a stack of six printheads and, optionally, a plurality of such stacks, preferably disposed along the whole of the length of the rotating drum. All the printheads are typically supported on a single “bridge” which optionally moves laterally during a multi-revolution printing cycle. FIG. 3 illustrates an alternative printhead array 40 in which printheads in successive layers overlap. In both FIG. 2 and FIG. 3, an optional order of printheads is white printheads 24 above cyan printheads 61 above magenta printhead 62 above yellow printhead 63 above process black printhead 64 and reserve printhead 67, which may be used, for example, for another white ink channel to speed the printing of a white base layer, or a spot color or, as another example, a clear varnish to protect the design layer inks, for example from abrasion. Upon completion of the printing process, substrate 10 is discharged onto table 60 or, optionally in the case of solvent ink, onto a conveyor belt, through an ink drying tunnel.

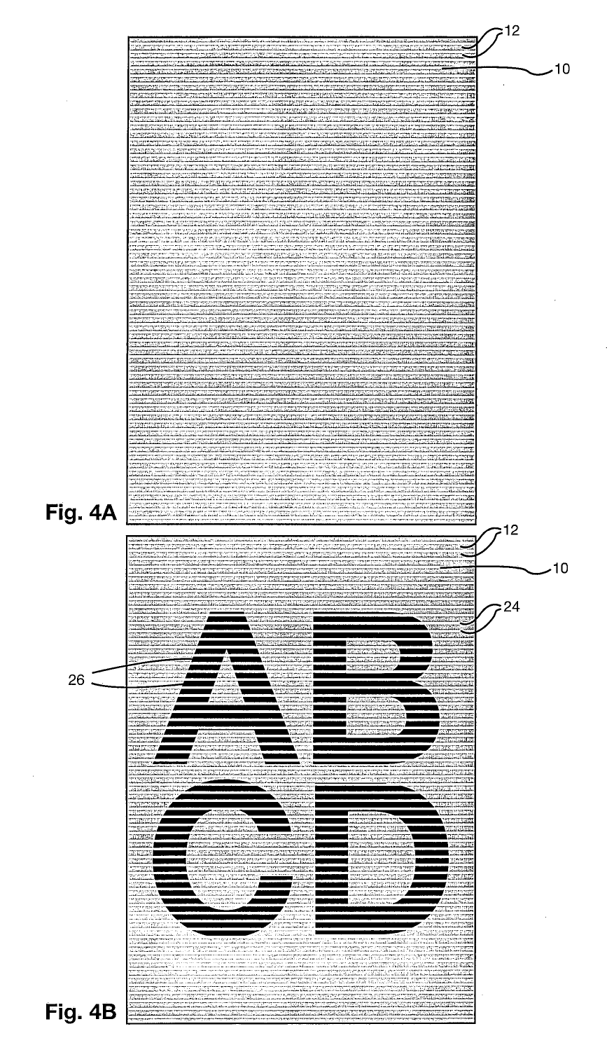

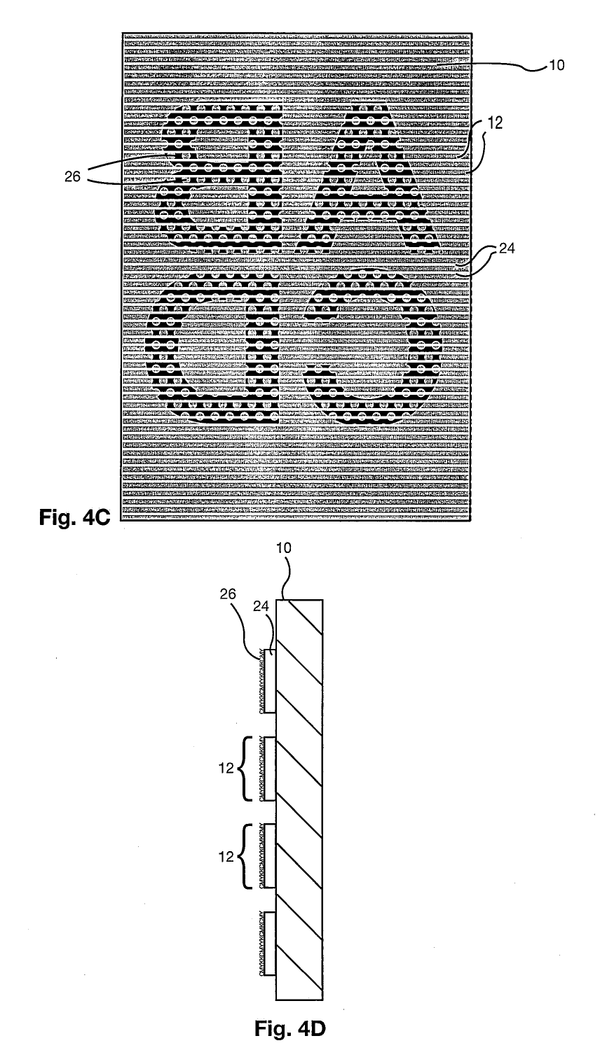

FIGS. 4A-D illustrate the production of a see-through graphics panel comprising a translucent white base layer 24, typically white, and a CMYK design layer 26 within a print pattern of lines 12 according to U.S. Pat. No. 6,212,805. FIG. 4A shows substrate 10 printed with a first layer comprising white ink 24, for example in a cycle of 27 revolutions of an HP Scitex TJ8500 UV ink jet cylinder printer, followed by a 27 revolution cycle of printing four color process design layer 26. FIG. 4C illustrates the other side of the panel of FIG. 4B, which typically would reveal a reverse image of CMYK design layer 26, owing to the translucent nature of the white base layer 24. FIG. 4D is a cross-section through a print pattern of lines 12 on substrate 10, typically a transparent sheet of film material, for example acrylic sheet or polyester film.

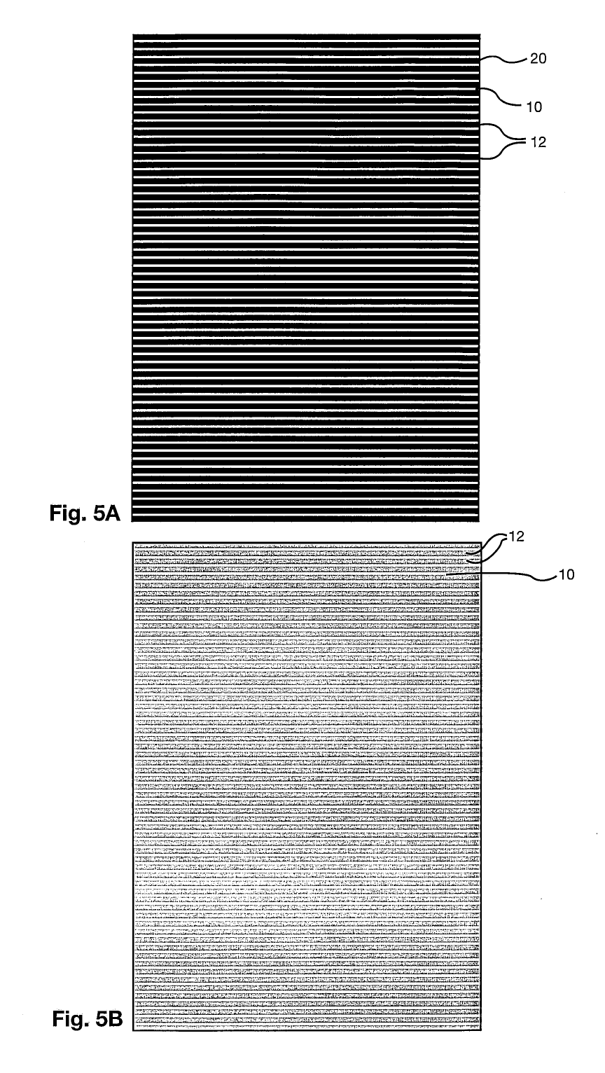

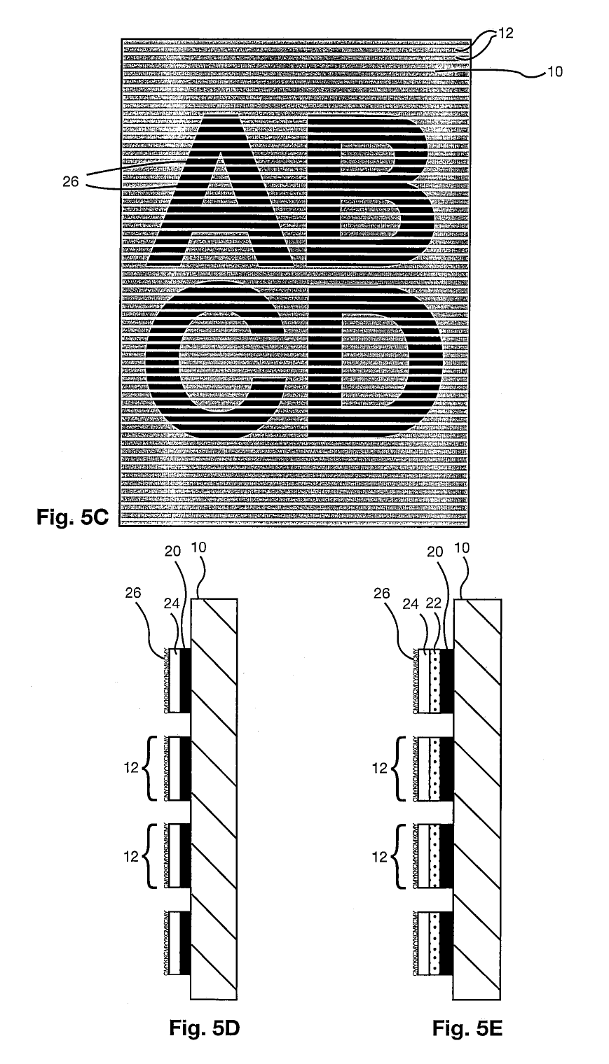

FIGS. 5A-D illustrate the printing of a see-through graphics panel according to U.S. RE37,186 with an opaque silhouette pattern comprising base layer 20, typically black, applied as a first layer to substrate sheet 10, as illustrated in FIG. 5A. In FIG. 5B base layer 24, typically white, has been superimposed within print pattern 12 onto black base layer 20, optionally preceded by a “silver” or gray base layer 22, typically comprising an aluminum pigment, which provides an effective intermediate transition layer between the white and black layers to improve the “whiteness” of white base layer 24, to act as a background to the CMYK design layer 26, as illustrated in FIGS. 5C-E.

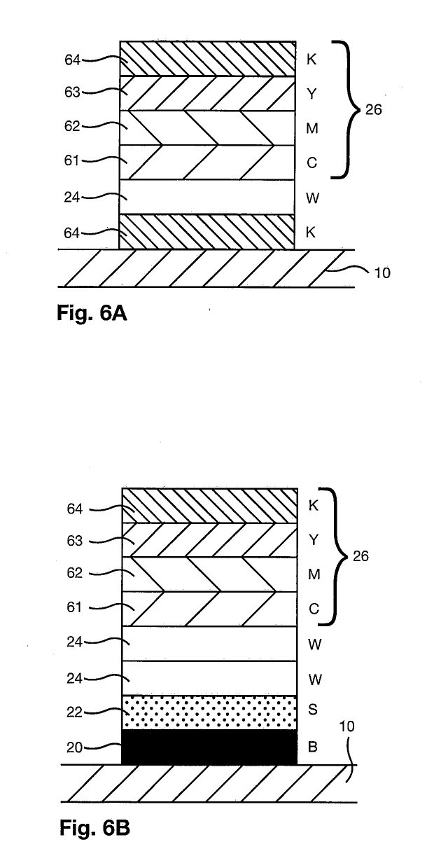

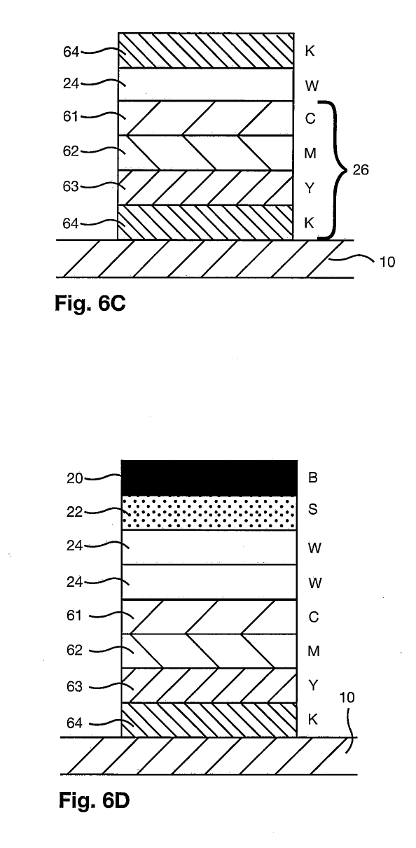

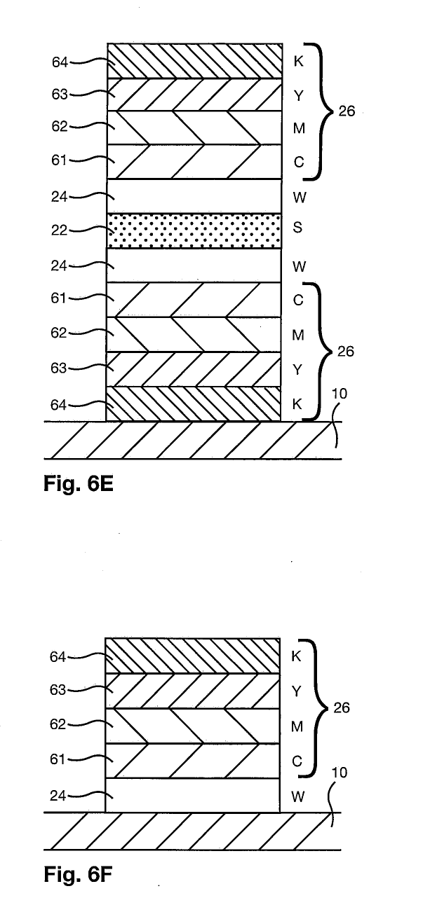

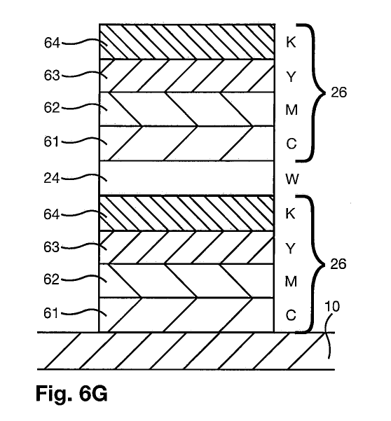

FIG. 6A is a cross-section through an individual line of silhouette pattern 12 in which dark base layer 20 comprises process black (K) ink 64, which may be built up by sufficient revolutions of the drum to provide an opaque black layer before printing white layer 24 and right-reading design layer 26 comprising CMYK layers 61, 62, 63 and 64. FIG. 6B illustrates an alternative arrangement in which dark layer 20 comprises a spot opaque black ink or alternatively a CMYK black layer in which all process colors are printed, typically to maximum density. Optional layer 22 comprises silver or gray ink as an intermediate layer between black and white ink layer or layers 24, a known method of improving the apparent whiteness of a white layer, to act as a background for a CMYK design layer 26. FIG. 6C illustrates a cross-section through an individual line of a silhouette pattern showing the optional reverse order of printing of FIG. 6A, in which a reverse-reading design 26, indicated by the order of KYMC, is followed by the printing of a white base layer 24 and black base layer 64 according to one of the previously described options. Similarly, FIG. 6D illustrates the reverse printing of FIG. 6B. FIG. 6C and FIG. 6D represent panels with designs which are intended to be seen through substrate 10, typically transparent film or sheet material. FIG. 6E illustrates a cross-section through an individual line of a see-through graphics panel in which a reverse-reading design layer 26 is first printed onto substrate 10, indicated by the order KMYC, followed by white layer 24, an “opacity layer” 22, for example of silver or gray ink, followed by another white layer, followed by a right-reading design layer 26, indicated by the order CMYK, which is either the same design as the first design or a different design being visible from either side of the panel. In these two embodiments, no reverse image is visible from the other side of the panel, for example as disclosed in U.S. RE37,186. FIG. 6F illustrates a cross-section through an individual line of a print pattern 12 through a panel with a translucent design 26 and translucent base layer 24, typically white, for example in accordance with U.S. Pat. No. 6,212,805, which allows the design to be illuminated from either side of the panel. FIG. 6G is a cross-section through a single line of a panel according to U.S. Pat. No. 6,212,805 in which a right-reading design is first printed on substrate 10, followed by a white layer followed by another design layer of the same right-reading design, all layers being translucent, providing a good quality image visible from each side which can be illuminated from either side of the panel.

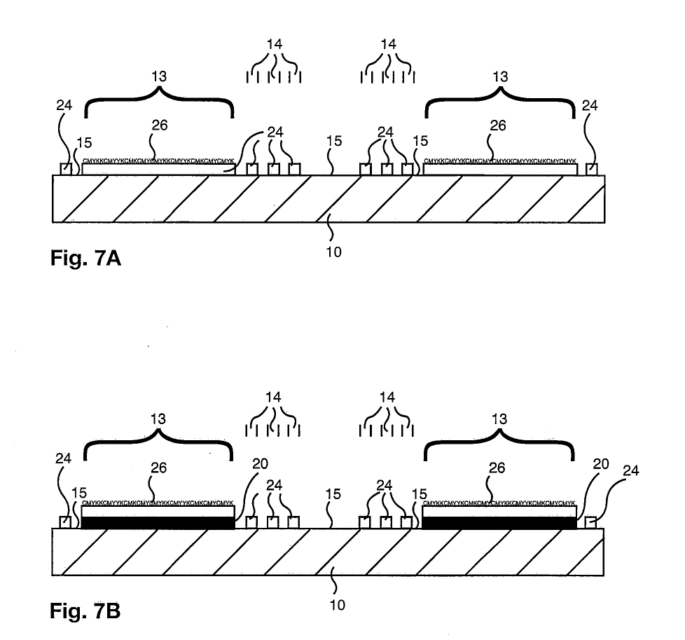

FIGS. 7A and 7B are cross-sections through part of a panel featuring a secondary print pattern 14, for example caused by inkjet spatter of base layer ink 24, typically white ink. FIG. 7A shows a panel of otherwise similar construction to FIG. 4A comprising substrate 10, base layer 24 and design layer 26 comprising CMYK inks. Secondary print pattern 14 comprising base layer 24 is located outside primary print pattern 24 with gaps 15 revealing substrate 10, typically transparent. FIG. 8A shows a panel of otherwise similar construction to FIG. 5A comprising substrate 10, base layer 24 and design layer 26.

The foregoing illustrated embodiments are provided to illustrate the structural and functional principles of the present invention and are not intended to be limiting. To the contrary, the principles of the present invention are intended to encompass any and all changes, alterations and/or substitutions within the spirit and scope of the following claims.

What is claimed is:

1. A panel comprising a substrate sheet partially imaged with a print pattern, said print pattern subdividing the panel into a plurality of discrete printed areas and/or a plurality of discrete unprinted areas, said design being superimposed on or forming a part of said print pattern, said design comprising a design layer, said print pattern comprising a base layer, said print pattern comprising elongate printed areas orientated lengthways in one direction, said design layer and said base layer comprising inkjet printable ink in elongate ink deposits orientated lengthways in said one direction, said elongate ink deposits having an aspect ratio of length:width greater than 1.5:1.

2. A panel as claimed in claim 1, wherein said aspect ratio is greater than 2.0:1.

3. A panel as claimed in claim 1, wherein said aspect ratio is greater than 2.5:1.

4. A panel as claimed in claim 1, wherein said print pattern is a pattern of lines.

5. A panel as claimed in claim 1, wherein said base layer comprises white ink.

6. A panel as claimed in claim 1, wherein said print pattern comprises indicia.

7. A panel as claimed in claim 1, wherein said design layer and said base layer comprise UV-curable inks.

8. A panel as claimed in claim 1, wherein said design layer and said base layer comprise solvent inks.

9. A method of making a panel, said panel comprising a substrate sheet partially imaged with a print pattern, said print pattern subdividing the panel into a plurality of discrete printed areas and/or a plurality of discrete unprinted areas, said design being superimposed on or forming a part of said print pattern, said design comprising a design layer, said print pattern comprising a base layer, said method comprising the steps of:
(i) providing a digital inkjet cylindrical printer comprising a cylindrical drum to support said substrate sheet and an array of inkjet printheads,
(ii) locating said substrate sheet onto said cylinder,
(iii) rotating said cylindrical drum,
(iv) inkjet printing said substrate sheet while said cylinder is rotating with a first layer, said first layer comprising one of said design layer and said base layer,
(v) then printing a second layer, said second layer comprising the other of said design color and base layer, both said design layer and said base layer being located within said print pattern.

10. A method as claimed in claim 9, wherein said print pattern is a pattern of lines.

11. A method as claimed in claim 9, wherein said print pattern comprises indicia.

12. A method as claimed in claim 9, wherein said design layer and said base layer comprise UV-curable inks.

13. A method as claimed in claim 9, wherein said design layer and said base layer comprise solvent inks.

14. A method as claimed in claim 9, comprising a disruptive instruction to said inkjet cylinder printer to suspend ejection of said substrate sheet.

15. A method as claimed in claim 9, wherein said rotating said cylindrical drum comprises over 10 rotations of said cylindrical drum while inkjet printing said base layer.

16. A method as claimed in claim 9, wherein said rotating said cylindrical drum comprises over 20 rotations of said cylindrical drum while inkjet printing said base layer.

17. A method as claimed in claim 9, wherein said rotating said cylindrical drum comprises over 30 rotations of said cylindrical drum while inkjet printing said base layer.

18. A method as claimed in claim 9, wherein said rotating said cylindrical drum comprises over 40 rotations of said cylindrical drum while inkjet printing said base layer.

19. A method as claimed in claim 9, wherein said base layer comprises white ink.

20. A method as claimed in claim 19, wherein another base layer comprises black ink.

21. A method as claimed in claim 19, wherein said white ink comprises less than 15% of pigment.

22. A method as claimed in claim 19, wherein said white ink comprises less than 12.5% of pigment.

23. A method as claimed in claim 19, wherein said white ink comprises less than 10% of pigment.

24. A panel comprising a substrate sheet partially imaged with a print pattern, said print pattern subdividing the panel into a plurality of discrete printed areas and/or a plurality of discrete unprinted areas, said design being superimposed on or forming a part of said print pattern, said design comprising a design layer, said print pattern comprising a base layer and another base layer, said print pattern comprising a primary print pattern and a secondary print pattern, wherein a cross-section can be taken through said panel comprising said sheet and alternate printed portions and unprinted portions, said printed portions comprising a plurality of primary print pattern portions and a plurality of secondary print pattern portions, and wherein each of said plurality of primary print pattern portions comprises a part of said base layer having two outer edges and a part of said another base layer having two outer edges, wherein said two outer edges of said part of said base layer are located within said two outer edges of said part of said another base layer, wherein in one of said primary print pattern portions said part of said design layer extends over only part of said width between said two outer edges of said part of said another base layer, and wherein a plurality of said plurality of secondary print pattern portions comprise other parts of said base layer having two outer edges and are devoid of said another base layer.

25. A panel as claimed in claim 24, wherein said base layer is white.

26. A panel as claimed in claim 24, wherein said base layer comprises inkjet ink spatter in a random pattern.

27. A panel as claimed in claim 24, wherein in each of said plurality of primary print pattern portions the width between said two outer edges of said part of said another base layer is greater than 0.5 mm, and wherein in each of said plurality of secondary print pattern portions the width between said two outer edges of said part of said base layer is less than 0.5 mm.

28. A panel as claimed in claim 24, wherein the aggregate width of said plurality of secondary print pattern portions is at least 10% of the aggregate width of said plurality of primary print pattern portions.
